(19) United States
(12) Patent Application Publication
(10) Pub. No.: US 2015/0070361 A1
(43) Pub. Date: Mar. 12, 2015

(54) CHARACTER CONVERSION SYSTEM AND A CHARACTER CONVERSION METHOD

(71) Applicants: Peking University Founder Group Co., Ltd., Beijing (CN); Founder Information Industry Group, Beijing (CN); Founder Apabi Technology Limited, Beijing (CN)

(72) Inventors: Jianbo Xu, Beijing (CN); Haopeng Sun, Beijing (CN); Li Ding, Beijing (CN); Haitao Wang, Beijing (CN); Leilei Geng, Beijing (CN)

(73) Assignees: Peking University Founder Group Co., Ltd., Beijing (CN); Founder Information Industry Group, Beijing (CN); Founder Apabi Technology Limited, Beijing (CN)

(21) Appl. No.: 14/095,749

(22) Filed: Dec. 3, 2013

(30) Foreign Application Priority Data
Sep. 12, 2013 (CN) 201310415209.X

(51) Int. Cl. G06T 11/60

(52) U.S. Cl. CPC G06T 11/60
USPC 345/467

(57) ABSTRACT

The present invention provides a character conversion system, comprising: a parsing unit, used to parse received data, determine at least one character contained in the data, and obtain property information corresponding to each character of the at least one character; a judging unit, used to, with respect to each character, determine a pattern bitmap of the character according to the property information, and judge whether the pattern bitmap satisfies a preset condition; a conversion unit, used to, if the judging unit judges that the preset condition is satisfied, determine an original inner code of the character according to the property information, and convert the character according to the original inner code; and if the judging unit judges that the preset condition is not satisfied, identify an actual inner code of the character according to the pattern bitmap, and convert the character according to the actual inner code.

### RELATED APPLICATIONS

The present application claims the benefit of priority to Chinese Patent Application No. 201310415209.X, filed Sep. 12, 2013, which is herein expressly incorporated by reference in its entirety.

### TECHNICAL FIELD

The present invention relates to word processing technical field, specifically, relates to a character conversion system and a character conversion method as well as a non-transient storage media storing a program that realizing the character conversion method.

### BACKGROUND

There are two types of Chinese characters, a simplified Chinese character and a traditional Chinese character. However, because of the big difference between the simplified Chinese character and the traditional Chinese character, it causes estrangement in information exchanging for users using these two types of characters. Not only for a user using the simplified Chinese character having a certain difficulty to read traditional Chinese character, but also for a user using the traditional Chinese character, who has never been exposed to the simplified Chinese character, he might only understands partial contents of a document in simplified Chinese character that he is reading. In addition, codes used in simplified Chinese character are different from the ones used in traditional Chinese character as well. The simplified Chinese character uses a GB (National Standard) code, the traditional Chinese character uses a Big 5 code. Therefore, a circumstance of displaying disordered codes will occur in the case that a user doesn't install a corresponding coding or decoding equipment in the local.

A conversion tool between the simplified and traditional Chinese characters is created just according to this demand. Almost every website or text editing software has a type conversion tool between the simplified and the traditional Chinese characters. But it's still not a easy task to convert a document in simplified Chinese character or in traditional Chinese character correctly. Usually a conversion between simplified and traditional Chinese characters is performed by searching a corresponding inner code of the traditional/simplified Chinese character according to the inner code of the simplified/traditional Chinese character. But when the inner code is incorrect, the converted content will be totally different from the actual content. This phenomenon of a character inner code being incompatible with its font is called a code disordered phenomenon.

The code disordered phenomenon usually exists in a document in a format that containing embedded font data, such as a document in PDF or ePub, etc. format. A document that containing disordered codes (incorrect inner code) is usually displayed normally, but occurs code disordering in the time of extracting or copying the characters. This is because that the document was created by specific fonts or embedded font data, which have suffered unusual changes while creating the document, and this leads to the document cannot provide right character inner codes. On the other hand, there is also some differences between the metric of the character pattern of a specific font and that of a general font, which might lead to a problem of abnormally displaying the character in size at the time of drawing a converted character using the general font. Due to historical reasons, there exists abound of the type of documents that containing disordered codes.

In order to convert a document containing a disordered code, it is only possible to reconstruct a document, or convert a document after identified characters thereof page by page by adopting an OCR (optical character recognition) technical means, however, either of the two methods consumes additional labor power resources.

Therefore, a new character conversion technology is needed, this technology can automatically correct an inner code error in the procedure of character conversion to reduce labor power consuming, and avoid the time consumption on identifying a fault document and repairing or reconstructing the document, so as to reduce system burden while converting the characters.

### SUMMARY

The present invention is aimed to solve the above issues, provides a character conversion technology, which can automatically correct a inner code error in a procedure of converting a character, thus to reduce labor power consuming, and avoid the time consumption on identifying a fault document and repairing or reconstructing the document, so as to reduce system burden while converting the characters.

For this purpose, the present invention provides a character conversion system, comprising: a parsing unit, configured to parse received data, determine at least one character contained in the data, and obtain property information corresponding to each character of the at least one character; a judging unit, configured to, with respect to each character, determine a pattern bitmap of the character according to the property information, and judge whether the pattern bitmap satisfies a preset condition; a conversion unit, configured to, in the case that the judging unit judged that the preset condition is satisfied, determine an original inner code of the character according to the property information, and convert the character according to the original inner code; and in the cast that the judging unit judged that the preset condition is not satisfied, identify an actual inner code of the character according to the pattern bitmap, and convert the character according to the actual inner code.

In the technical scheme, it is possible to determine whether the font inner code of the character to be converted is correct by judging whether the bitmap of the character to be converted satisfies the preset condition, when the font inner code is incorrect, the actual inner code of the character to be converted may be identified as a conversion basis to convert a character that to be converted, thus achieves the effect of automatically correcting inner code errors, avoiding time consumption on determining a fault document and repairing or reconstructing the document, and reducing the system burden in the procedure of character conversion.

The present invention also provides a character conversion method, comprising: parsing received data, determining at least one character contained in the data, and obtaining property information corresponding to each character of the at least one character; with respect to each character, determining a pattern bitmap of the character for each character according to the property information, and judging whether the pattern bitmap satisfies a preset condition, if the preset condition is satisfied, determining an original inner code of the character according to the property information, and converting the character according to the original inner code; if the preset condition is not satisfied, identifying an actual inner code of the character according to the pattern bitmap, and converting the character according to the actual inner code.

In the technical scheme, it is possible to determine whether the font inner code of the character to be converted is correct by judging whether the bitmap of the character to be converted satisfies the preset condition, when the font inner code is incorrect, the actual inner code of the character to be converted may be identified as a conversion basis to convert the character that to be converted, thus realizes the effect of automatically correcting inner code errors, avoiding time consumption on determining a fault document and repairing or reconstructing the document, and reducing system burden in the procedure of character conversion.

The present invention further provides a non-transient storage media, which storing a computer executable program for achieving the character conversion method.

In the technical scheme, it is possible to determine whether the font inner code of the character to be converted is correct by judging whether the bitmap of the character to be converted satisfies the preset condition, when the font inner code is incorrect, the actual inner code of the character to be converted may be identified as a conversion basis to convert a character that to be converted, thus realizes the effect of automatically correcting inner code errors, avoiding time consumption on determining a fault document and repairing or reconstructing the document, and reducing system burden in the procedure of character conversion.

By utilizing above technology scheme, it is capable to automatically correct the inner code errors in the procedure of character conversion by above mentioned technology scheme, which reduces labor-power consumption, and avoid the time consumption on identifying a fault document and repairing or reconstructing the document, so as to reduce system burden while converting the characters.

### BRIEF DESCRIPTION OF THE DRAWINGS

FIG. 1 shows a block diagram of the character conversion system according to the embodiment of the present invention;

FIG. 2 shows a flow chart of the character conversion method according to the embodiment of the present invention;

FIG. 3 shows a structure diagram of the character conversion system according to the embodiment of the present invention;

FIG. 4 shows a specific flow chart of the character conversion method according to the embodiment of the present invention;

FIG. 5 shows a flow chart for determining the pattern similarity according to the embodiment of the present invention;

FIG. 6 A and FIG. 6 B show a schematic diagram of pattern conversion according to the embodiment of the present invention.

### DETAILED DESCRIPTION

In order to understand above mentioned purpose, features and advantages of the present invention more clearly, a further detailed description of the present invention in combination with drawings and embodiment of the invention will be given in the below. It should be noted that, in the case of not conflicting, embodiments and characteristics in embodiments of the present application may be combined with each other.

In the following description, a number of specific details is described in order to make the present invention to be fully understood. However, the present invention may be carried out also by adopting other modes that different from the ones in the description, therefore, the protection scope of the present invention should not be restricted by the following disclosed specific embodiments.

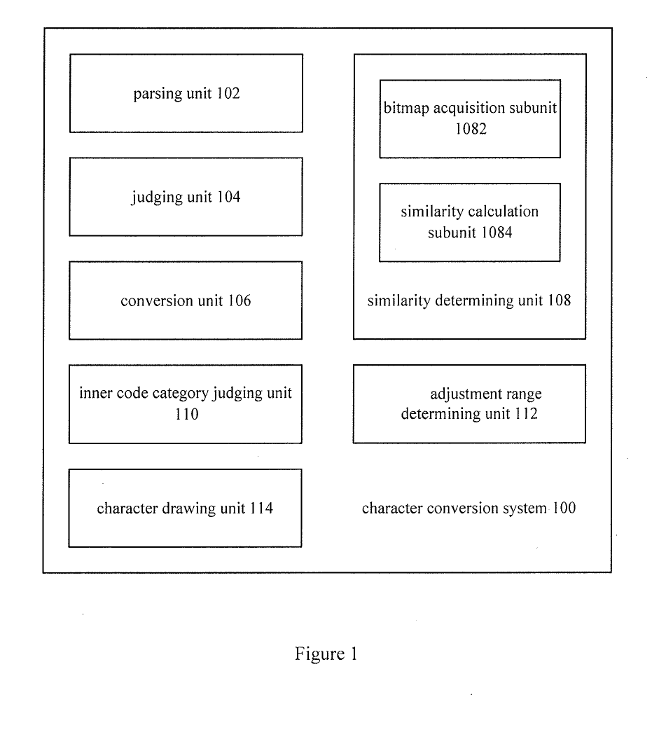

FIG. 1 shows a block diagram of the character conversion system according to the embodiments of the present invention.

As shown in FIG. 1, the character conversion system 100 according to the embodiment of the present invention comprises: a parsing unit 102, used to parse received data, identify at least one character contained in the data, and obtain property information corresponding to each character of the at least one character; a judging unit 104, with respect to each character, the judging unit is used to determine a pattern bitmap of the character for each character according to the property information, and judge whether the pattern bitmap satisfies a preset condition; a conversion unit 106, in the case that the judging unit 104 judges that the preset condition is satisfied, the conversion unit 106 is configured to determine an original inner code of the character according to the property information, and convert the character according to the original inner code; and in the case that the judging unit 104 judges the preset condition is not satisfied, identify an actual inner code of the character according to the pattern bitmap, and convert the character according to the actual inner code.

In the above mentioned technical scheme, preferably, also comprises: a similarity determining unit 108, used to determine a pattern bitmap of a character according to the property information, compare the pattern bitmap with a standard bitmap to obtain pattern similarity, and determine average similarity according to the pattern similarity of each character, wherein, the judging unit 104 is used to judge whether the average similarity is greater than or equal to a preset threshold, the conversion unit 106, in the case that the judging unit 104 judges that the average similarity is greater than or equal to the preset threshold, the conversion unit 106 is used to determine an original inner code of the character according to the property information, and convert the character to a first target character according to the original inner code; and in the case that the judging unit 104 determines the average similarity is less than the preset threshold, the conversion 106 identifies an actual inner code of the character according to the pattern bitmap, and convert the character to a second target character according to the actual inner code.

It is capable to determine whether the font inner code of the character to be converted is correct by calculating the similarity between the bitmap of the character to be converted and the standard bitmap, then judging the relationship between the similarity and the preset threshold. When the font inner code is not correct, the actual inner code of the character to be converted may be identified as a conversion basis to convert the character to be converted to a second target character, thus realizes the effect of automatically correcting inner code errors, avoiding time consumption on determining a fault document and repairing or reconstructing document, and reducing system burden in the procedure of character conversion.

Preferably, the similarity determining unit 108 comprises: a bitmap acquisition subunit 1082, used to determine a font corresponding to the character respectively according to the property information, and obtain pattern bitmaps of a preset quantity of characters corresponding to each type of font, as well as obtain standard bitmaps of a preset quantity of characters based on a standard font; a similarity calculation subunit 1084, used to compare the pattern bitmap with the standard bitmap to obtain pattern similarity, determine average similarity according to the pattern similarity of each character, so as to judge whether the average similarity is greater than or equal to a preset threshold.

Specifically, this can be achieved as following: according to the font of the character to be converted, obtain pattern bitmaps of a certain quantity of the characters; then, the standard bitmaps of the above mentioned characters based on a standard font (such as SimSun font) is obtained according to the inner code in the property information (i.e., the original inner code); then, in order to determine the pattern similarity, compare the pattern bitmap of each character with its standard bitmap, and calculate average similarity according to the pattern similarity of each character, thus to correctly judge which one of the pattern similarity of the character to be converted and the preset threshold value is bigger, furthermore to correctly judge whether the font inner code of the character to be converted is correct.

Preferably, the system also comprises: an inner code category judging unit 110, used to judge whether the original inner code of the character attributes to a preset category according to the property information; wherein, in the case that the result determined by the inner code category judging unit 110 is yes, the bitmap acquisition subunit 1082 determines the fonts corresponding to the characters respectively according to property information.

At the time of converting a character, performing the conversion only if the inner code of the character to be converted attributes to the inner code in a certain category. For example, when a simplified Chinese character is converted to a traditional Chinese character, if the inner code of the character to be converted is detected as a simplified Chinese character inner code, which attributes to the Chinese inner code category, the conversion is performed; but, if the character to be converted is detected as consisting a character whose inner code is a digital inner code, the conversion of the character is not performed.

Preferably, the system also comprises: an adjustment range determining unit 112. used to compare the bigger value of the height value and width value of the pattern bitmap with the larger value of the height and width of the standard bitmap, so as to obtain a pattern adjustment range; a character drawing unit 114, used to adjust a first font size of the first target character according to the pattern adjustment range corresponding to the first target character, draw the first target character according to the calibrated first font size, calibrate the second font size of the second target character according to the pattern adjustment range corresponding to the second target character, and draw the second target character according to the calibrated second font size, and/or draw a character that is not converted according to the font size of the character that is not converted.

Before drawing the converted character, if the inner code of the character to be drawn has been corrected (i.e. has been replaced with the actual inner code), then adjusting the font size of the character with the pattern adjustment range, so that the converted font size can be compatible with the font size before converted.

Preferably, the conversion unit 106 identifies the pattern bitmap by optical character recognition technology to obtain an actual inner code.

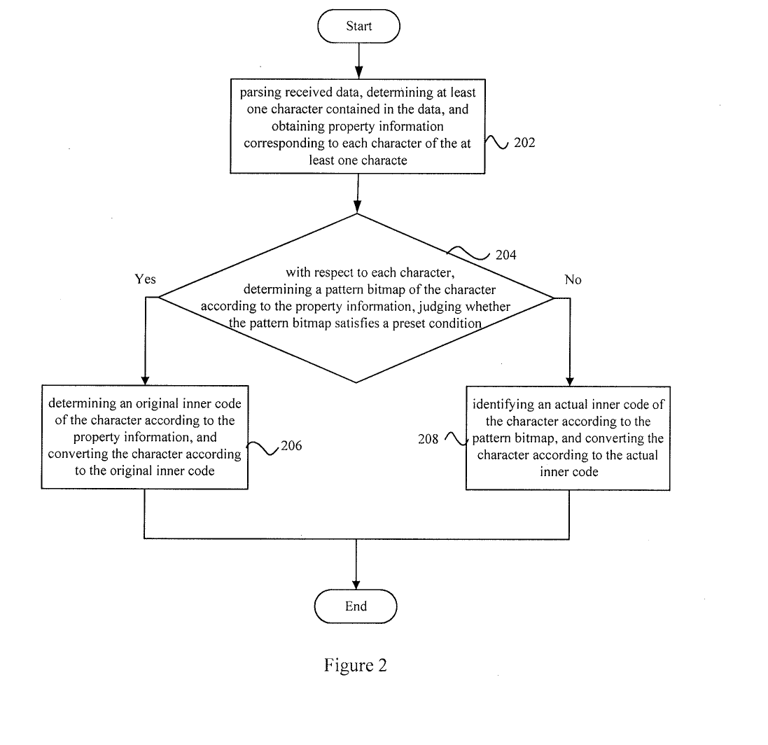

FIG. 2 shows a flow chart of the character conversion method according to the embodiments of the present invention.

As shown in FIG. 2, the character conversion method according to the embodiment of the present invention comprises: parsing received data, determining at least one character contained in the data, and obtaining property information corresponding to each character of the at least one character; with respect to each character, determining a pattern bitmap of the character according to the property information, and judging whether the pattern bitmap satisfies a preset condition, if the preset condition is satisfied, determining an original inner code of the character according to the property information, and converting the character according to the original inner code; if the preset condition is not satisfied, identifying an actual inner code of the character according to the pattern bitmap, and converting the character according to the actual inner code.

Preferably, the process of judging whether the pattern bitmap satisfies the preset condition comprises: comparing the pattern bitmap with a standard bitmap to obtain pattern similarity, determining average similarity according to the pattern similarity of each character, judging whether the average similarity is greater than or equal to the preset threshold; if the average similarity is greater than or equal to the preset threshold, determining an original inner code of the character according to the property information, converting the character to a first target character according to the original inner code; if the average similarity is less than the preset threshold, identifying an actual inner code of the character according to the pattern bitmap, and converting the character to a second target character according to the actual inner code.

It is possible to determine whether the font inner code of the character to be converted is correct by calculating the similarity between the bitmap of the character to be converted and the standard bitmap, then judging the relation between the similarity and the preset threshold. When the font inner code is not correct, the actual inner code of the character to be converted may be identified as a conversion basis to convert the character to be converted to a second target character, thus realizes the effect of automatically correcting inner code errors, avoiding time consumption on determining a fault document and repairing or reconstructing document, and reducing system burden in the procedure of character conversion.

Preferably, the process of comparing the pattern bitmap with the standard bitmap comprises: determining a font corresponding to the character respectively according to the property information, and obtaining pattern bitmaps of a preset quantity of characters corresponding to each type of font, as well as obtaining standard bitmaps of a preset quantity characters based on a standard font; comparing the pattern bitmap with the standard bitmap to obtain pattern similarity, determining average similarity according to the pattern similarity of each character, so as to judge whether the average similarity is greater than or equal to the preset threshold.

It is possible to obtain pattern bitmaps of a certain quantity of the characters to be converted according to the font thereof, then, the standard bitmaps of the above mentioned characters based on a standard font (such as SimSun font) is obtained according to inner code in the property information (i.e., the original inner code); then, comparing the pattern bitmap of each character with its standard bitmap to determine the pattern similarity, and calculate average similarity according to the pattern similarity of each character, thus it is possible to correctly judge which one of the pattern similarity of the character to be converted and the preset threshold value is bigger, furthermore to correctly judge whether the font inner code of the character to be converted is correct.

Preferably, the method also comprises: judging whether the original inner code of the character attributes to a preset category according to property information, if so, converting the character, if not, not converting character.

At the time for converting character, performing the conversion only if the inner code of the character to be converted attributes to the inner code of a certain category. For example, when a simplified Chinese character is converted to a traditional Chinese character, if the inner code of the character to be converted is detected as a simplified Chinese character inner code, which attributes to the Chinese inner code category, the conversion is performed; but, if the character to be converted is detected as consisting a character whose inner code is a digital inner code, the conversion of the character is not performed.

Preferably, the method also comprises: comparing the larger value of the height and width of the pattern bitmap with the larger value of the height and width of the standard bitmap to obtain a pattern adjustment range; the character conversion method also comprises: adjusting the first font size of the first target character according to the pattern adjustment range corresponding to the first target character, drawing the first target character according to the calibrated first font size, calibrating the second font size of the second target character according to the pattern adjustment range corresponding to the second target character, and drawing the second target character according to the calibrated second font size, and/or drawing a character that is not converted according to the font size of the character that is not converted.

Before drawing the converted character, if the inner code of the character to be drawn has been corrected (i.e., has been replaced with the actual inner code), then adjusting the font size of the character with the pattern adjustment range, so that the converted font size can be compatible with the font size before converted.

Preferably, the method also comprises: identifying the pattern bitmap by optical character recognition technology to obtain the actual inner code.

The following will descript the embodiments of the present invention taking instance of converting simplified Chinese characters to traditional Chinese characters.

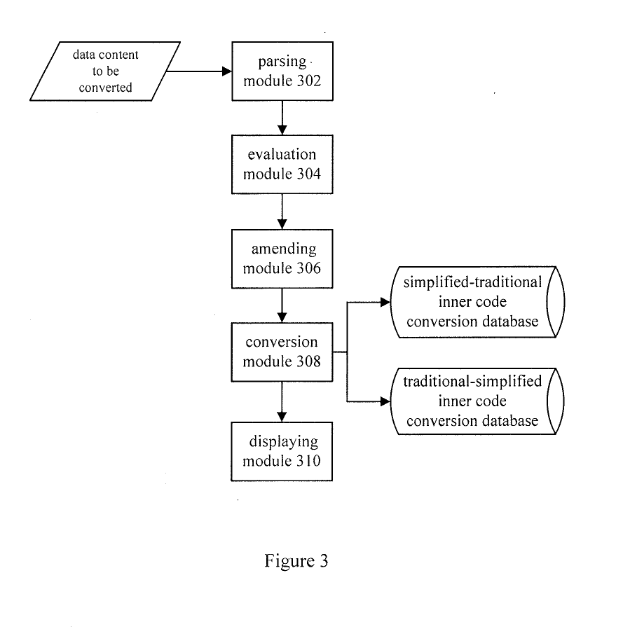

FIG. 3 shows a structure diagram of the character conversion system according to the embodiments of the present invention.

As shown in FIG. 3, the character conversion system 100 according to the embodiment of the present invention may comprise: a parsing module 302, an evaluation module 304, an amending module 306, a conversion module 308, and a displaying module 310.

A simplified-traditional inner code conversion database stores all inner codes of the simplified Chinese characters and the corresponding inner codes of the traditional Chinese characters; a traditional-simplified inner code conversion database stores all inner codes of the traditional Chinese characters and the corresponding inner codes of the simplified Chinese characters.

The parsing module 302 is used to parse the received data content to a font resource and a character content;

The evaluation module 304 is used to evaluate various fonts to determine the font needs to be corrected, and calculate the pattern measurement adjustment value for each font;

The amending module 306 is used to amend the character content which uses a font containing a error inner code;

The conversion module 308 is used to convert the characters in the character content to the corresponding traditional/simplified Chinese character one by one;

The displaying module 310 is used to draw the converted character content to an output device, such as a screen or a printer.

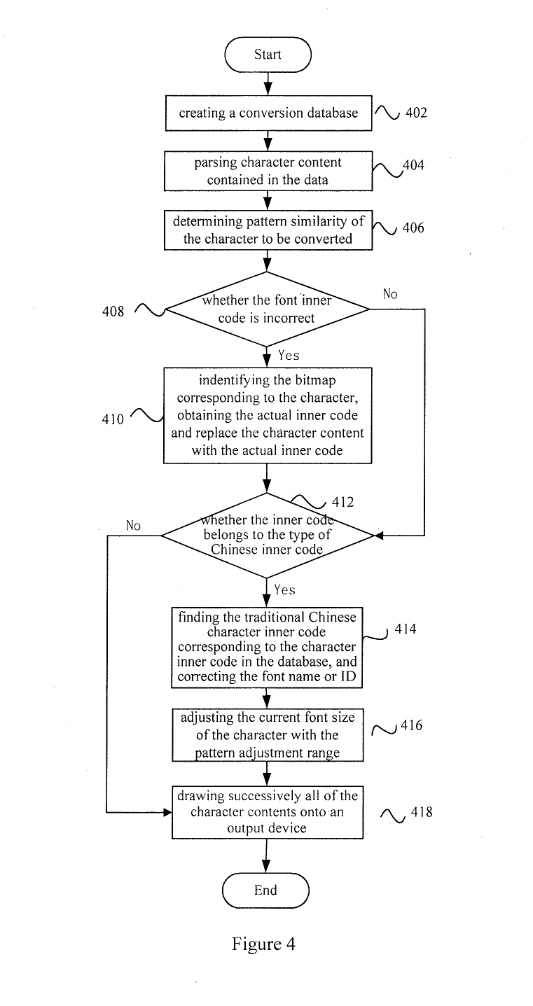

FIG. 4 shows a specific flow chart of the character conversion method according to the embodiments of the present invention.

As shown in FIG. 4, the character conversion method according to embodiment of the present invention specifically comprises:

Step 402, creating a conversion database containing multiple simplified Chinese character inner codes and the corresponding traditional Chinese character inner codes, and a conversion database containing multiple traditional Chinese character inner codes and the corresponding simplified Chinese character inner codes;

Step 404, receiving a data content (such as a PDF document), and parsing various font resources and all of the character contents contained therein, wherein the character contents contain the property information, to which the character contents attribute, on the font name or number (the number distributed for the font by the system, which is used to identify the font), the font size (used to describe the size of the character that being drawn), etc., the pattern code corresponding to the character contents and the corresponding character inner codes;

Step 406, evaluating each type of the font, selecting a certain quantity of character samples from the pared character content, wherein, all of these character samples use the fonts being evaluated, and their inner codes are in the range of the simplified Chinese character inner codes; obtaining a pattern bitmap corresponding to the font being evaluated and a pattern bitmap corresponding to the standard font (such as SimSun font) in a same font size for the character samples respectively, comparing these two pattern bitmaps in the aspect of pattern (a regular process step in OCR) o obtain the pattern similarity, then, obtaining the pattern measurement adjustment range by dividing two side lengths of the respective bitmaps (each of the side lengths refers to the bigger one of the width and the height of each bitmap), finally calculating the average value of the similarity of the character samples and the average value of the pattern measurement adjustment rang;

Step 408, judging whether the average value of the similarity is less than the preset threshold, if the average value is greater than or equal to the preset threshold, proceeding to step 412;

Step 410, if the average value of the similarity is less than the preset threshold, judging the current font inner code of the character as being incorrect and needs to be corrected, identifying the pattern bitmap corresponding to the character by the function of OCR to obtain the correct character inner code (i.e., the actual inner code), and replacing the inner code in the character content;

Step 412, judging whether the character inner code is in the range of the Chinese character inner code, if the character inner code is outside the range of the Chinese character inner code, the conversion of the characters is not needed;

Step 414, if the character inner code is in the range of the Chinese character inner code, searching the traditional Chinese character inner code corresponding to the character inner code in the database of simplified-traditional inner code conversion database, and changing its font name or number to the ones of a default traditional Chinese character font (such as MingLiU font) respectively;

Step 416, drawing successively all of the character contents, the converted character may be drawn by obtaining its corresponding pattern bitmap according to the inner code, calibrating the font size of the current character with the pattern adjustment range before drawing;

Step 418, the character that is not converted might be drawn by obtaining the corresponding pattern bitmap according to the pattern code.

By utilizing above technology scheme, the embodiment of the present invention reduces time consumption on identifying a fault document and repairing or reconstructing the document, so that achieved the technical effect of reducing system burden.

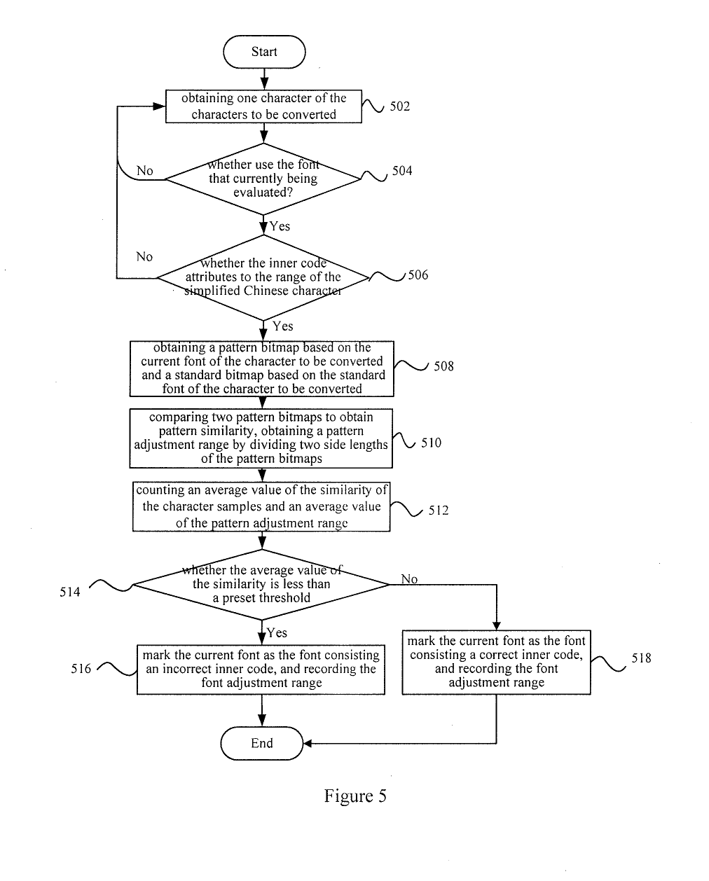

FIG. 5 shows a flow chart of judging the pattern similarity according to the embodiment of the present invention.

As shown in FIG. 5, the method for judging pattern similarity comprises:

Step 502, obtaining a character of the characters to be converted;

Step 504, judging whether the font of the character is the font currently being evaluated, if it is not, return to step 502 to obtain a next character;

Step 506, if the font of the character is the font currently being evaluated, judging whether the inner code of the character is in the range of the simplified Chinese character inner code, if it is not in the range, return to Step 502 to obtain a next character;

Step 508, if the inner code of the character is in the range of the simplified Chinese character inner code, obtaining the pattern bitmap of the character based on the current font and the standard bitmap based on the standard font of the character;

Step 510, comparing the pattern similarity of the pattern bitmap and the standard bitmap, and obtaining the larger value of the height and the width of the font bitmap, comparing with the larger value of the height and the width of the standard bitmap to obtain the pattern adjustment range;

Step 512, calculating an average value of the pattern similarity and an average value of the pattern adjustment range of a certain quantity of characters;

Step 514, judging whether the average value of the pattern similarity is less than the preset threshold;

Step 516, if it is less than the preset threshold, judging the current font of the character as a font consisting a incorrect inner code, recording the corresponding pattern adjustment range;

Step 518, if it is greater than the preset threshold, judging the current font of the character as the font consisting a correct inner code, recording the corresponding pattern adjustment range.

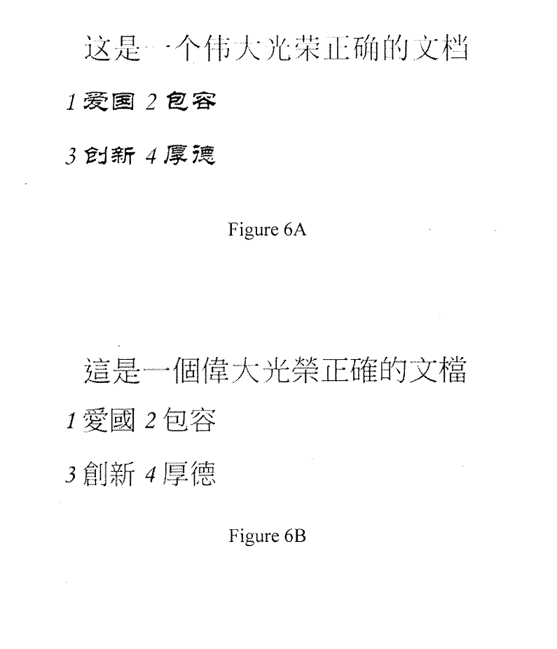

FIG. 6 A and FIG. 6 B show a schematic diagram illustrating the pattern conversion according to the embodiment of the present invention.

For example, there is a document as shown in FIG. 6 A, which is needed to be converted from the simplified Chinese character to the traditional Chinese character. According to the parsed font resources, wherein, the first line of the character contents uses a font resource in font A, and its inner code is correct, other character contents use a font resource in font B, and their inner codes is not correct.

First of all, create a conversion database containing multiple inner codes of the simplified Chinese characters and the corresponding inner codes of the traditional Chinese character and a conversion database containing multiple inner codes of the traditional Chinese character and the corresponding inner codes of the simplified Chinese characters, parse the two types of the fonts used in the document and all of the character contents therein, wherein, there are a lot of pattern description information included in the fonts, certain pattern description information may be obtained by the pattern code, and thus to obtain the a character bitmap. A character content is composed of the font name or ID of each character, its corresponding pattern code and the corresponding character inner code. Specifically, a character content is shown in table 1:

TABLE 1

| | | | Pattern | | Traditional Chinese |
|---|---|---|---|---|---|
| Character | Font Name | Font Size | Code | Character Inner Code | Character Inner Code |
| [symbol] | font A | 15 | 01 | 36825 | 36889( [symbol] ) |
| [symbol] | font A | 15 | 02 | 26159 | 26159( [symbol] ) |
| . . . | . . . | . . . | . . . | . . . | |
| 1 | font B | 10 | 01 | 65(correct: 49) | 49(1) |
| [symbol] | font B | 10 | 02 | 28907(correct: 29233) | 24859( [symbol] ) |
| [symbol] | font B | 10 | 03 | 22351(correct: 22269) | 22283( [symbol] ) |
| . . . | . . . | . . . | . . . | . . . | |

Then, evaluate whether the parsed two types of fonts (i.e., font A and font B) is correct or not, assuming that the number of the samples is 5, for the font A, judge the characters in the document successively, for example, the character samples selected are “ [symbol] ”, “ [symbol] ”, “ [symbol] ”, “ [symbol] ”, “ [symbol] ”, obtain the pattern bitmap based on the font A and the pattern bitmap based on the SimSun font are successively obtained for the five samples respectively, wherein the pattern bitmap of SimSun font is obtained by searching the character inner code, for example, the sample “ [symbol] ”, its inner code 36825 is corresponding to the character “ [symbol] ” of the simplified Chinese character, the pattern similarity is obtained by comparing the obtained pattern bitmap of “ [symbol] ” in the SimSun font and the pattern bitmap corresponding to the font A, pattern code 01; calculated the ratio of the side length of the pattern bitmap corresponding to the font A pattern code 01 to the side length of the pattern bitmap of the character “ [symbol] ” in the SimSun font, and make this ratio as the pattern adjustment rang, the similarity and the pattern measurement adjustment range of the rest of four samples are calculated in the same way, and the average value is calculated, compare the average value of the similarity with the threshold, if the similarity is greater than or equal to the threshold, the font A can be judged as the font consisting of correct inner code and the font measurement adjustment range is recorded.

For the font B, because the inner codes of the character “1” and the character “2” are not in the range of the simplified Chinese character, the selected character samples are “ [symbol] ”, “ [symbol] ”, “ [symbol] ”, “ [symbol] ” and “ [symbol] ”. The pattern bitmap based on the font B and the pattern bitmap based on the SimSun font are successively created for the five samples respectively, wherein the pattern bitmap of the SimSun font is searched by the character inner code. For example, for the sample “ [symbol] ”, the parsed inner code is 28907 (its actual inner code should be 29233), which is corresponding to the Chinese character “ [symbol] ”. Obtain the pattern similarity by comparing the obtained pattern bitmap of “ [symbol] ” in the SimSun font and the pattern bitmap corresponding to the font B, pattern code 02, and calculate a ratio of the side length of the pattern bitmap corresponding to the font B, pattern code 02 to the side length of the pattern bitmap of “ [symbol] ” in the SimSun font, make this ratio as the pattern measurement adjustment range; and likewise, calculate the similarity and the font measurement adjustment range for each of the rest four samples, and calculate the average value of them. Since none of the inner codes of the other four samples in the font B is corresponding to the right character, the calculated average value of the similarity is less than the threshold, therefore, the font B is judged as the font consisting incorrect inner codes.

Next, to correct the characters using the font consisting incorrect inner codes, whereas, the characters using the font A may skip this process for correcting. The characters using the font B are processed successively, take the first character “1” as an example, first of all, obtain its pattern bitmap corresponding to the font A, then identify this pattern bitmap by OCR, so that a correct character inner code “49” is obtained and is replaced into the character content, and likewise, all of the rest characters are corrected.

Then, the characters are converted, take the character “ [symbol] ” which uses the font A as an example, in the simplified-traditional inner code conversion database, it can be found that the inner code 36825 is corresponding to the inner code 36889 of the traditional Chinese character, then, the font name of the character “ [symbol] ” is changed to the default font of the MingLiU font. For the font B, the inner code of the character “1” is 49, which is not in the range of the Chinese character inner code, therefore the conversion step is skipped. Next, for the character “ [symbol] ”, in the simplified-traditional inner code conversion database, it can be found that the inner code 29233 is corresponding to the inner code 24859, therefore, the inner code of “ [symbol] ” is replaced with 24859, the font name of the character “ [symbol] ” is changed to the default font of the MingLiU font. Likewise, all of the rest characters are converted.

Finally, display the converted characters on an output device, all of the characters can be successively drawn to a large bitmap. Here, it needs to process the converted characters and characters not been converted differently. The pattern bitmap based on the default font of the “MingLiU font” may be used at the time of drawing the converted characters, wherein, the font size of the currently drawn character needs to be calibrated with the pattern adjustment range, such as most of the characters that using the font B, its calibrated font size is obtained by timing the pattern adjustment range by the former font size; the characters that not been converted may be drawn using the former font size, such as all of the characters using the font A and the characters of non-simplified Chinese character that using the font B.

In the above, the technical scheme of the present invention has been described in detailed with reference to the drawings, in view of the related technology, in order to convert a document containing a disordered code, it needs to reconstruct the document, or adopt the technical means of OCR to identify the characters page by page, to convert it once again, which wastes labor-power resources. Through the technical scheme of the present invention, it is capable to correct a incorrect inner code in the procedure of converting a character, which reduces labor-power consumption, and avoid time consumption on determining a fault document and repairing or reconstructing the document, so as to reduce system burden at the time of converting the character.

In the present invention, the terms of “first”, “second” are only used for describing purpose, which can not be understood as instructing of implying the relative importance. The terms of “multiple” points to a number of two or more than two, unless it is instructed to the otherwise.

Exemplary embodiments of the present application have been described above with reference to the accompanying drawings. A person skilled in the art should understand that the above embodiments are only cited examples for illustrative purposes, instead of for restricting, any modification, equivalent replacement, etc. which is made in the scope of the protection of the teachings and claims of the present application, should be included within the scope of the protection claimed by this application.

What is claimed is:

1. A character conversion system, comprising:
a parsing unit, configured to parse received data, determine at least one character contained in the data, and obtain property information corresponding to each character of the at least one character;
a judging unit, configured to, with respect to each character, determine a pattern bitmap of the character according to the property information, and judge whether the pattern bitmap satisfies a preset condition; and
a conversion unit, configured to, if the judging unit judges that the preset condition is satisfied, determine an original inner code of the character according to the property information, and convert the character according to the original inner code; if the judging unit judges that the preset condition is not satisfied, identify an actual inner code of the character according to the pattern bitmap, and convert the character according to the actual inner code.

2. The character conversion system according to claim 1, further comprising:
a similarity determining unit, configured to determine the pattern bitmap of the character according to the property information, compare the pattern bitmap with a standard bitmap to obtain pattern similarity, determine average similarity according to the pattern similarity of each character;
wherein, the judging unit is configured to judge whether the average similarity is greater than or equal to a preset threshold, if the judging unit determines the average similarity is greater than or equal to the preset threshold, the conversion unit is configured to determine the original inner code of the character according to the property information, convert the character to a first target character according to the original inner code, and if the judging unit determines the average similarity is less than the preset threshold, the conversion unit is configured to identify the actual inner code of the character according to the pattern bitmap, and convert the character to a second target character according to the actual inner code.

3. The character conversion system according to claim 2, wherein the similarity determining unit comprises:
a bitmap acquisition subunit, configured to determine font types corresponding to the characters according to the property information, and obtain pattern bitmaps of a preset quantity of characters corresponding to each type of font, and obtain standard bitmaps of the preset quantity of characters based on a standard font; and
a similarity calculation subunit, configured to compare the pattern bitmap with the standard bitmap to obtain pattern similarity, to determine the average similarity according to the pattern similarity of each character, judge whether the average similarity is greater than or equal to the preset threshold.

4. The character conversion system according to claim 2, further comprises:
an adjustment range determining unit, configured to compare the bigger value of the height and the width of the pattern bitmap with the bigger value of the height and the width of the standard bitmap, to obtain a pattern adjustment range; and
a character drawing unit, configured to adjust a first font size of the first target character according to the pattern adjustment range corresponding to the first target character, draw the first target character according to the calibrated first font size, calibrate a second font size of the second target character according to the pattern adjustment range corresponding to the second target character, and draw the second target character according to the calibrated second font size, and/or draw a character that is not being converted according to the font size of the character that is not converted.

5. The character conversion system according to claim 1, wherein the conversion unit identifies the pattern bitmap of the character by an optical character recognition technology to obtain the actual inner code.

6. A character conversion method, comprising:
parsing received data, determining at least one character contained in the data, and obtaining property information corresponding to each character of the at least one character;
with respect to each character, determining a pattern bitmap of the character according to the property information, and judging whether the pattern bitmap satisfies a preset condition, if the preset condition is satisfied, determining an original inner code of the character according to the property information, and converting the character according to the original inner code; if the preset condition is not satisfied, identifying an actual inner code of the character according to the pattern bitmap, and converting the character according to the actual inner code.

7. The character conversion method according to claim 6, wherein the process of judging whether the pattern bitmap satisfies the preset condition comprises: comparing the pattern bitmap with a standard bitmap to obtain pattern similarity; determining average similarity according to the pattern similarity, and comparing the average similarity with the preset threshold;
determining, if the average similarity is greater than or equal to the preset threshold, the original inner code of the character according to the property information, converting the character to a first target character according to the original inner code; and
identifying, if the average similarity is less than the preset threshold, the actual inner code of the character according to the pattern bitmap, and converting the character to a second target character according to the actual inner code.

8. The character conversion method according to claim 7, wherein the process of comparing the pattern bitmap with the standard bitmap comprises:
determining font types corresponding to the characters according to the property information, and obtaining pattern bitmaps of a preset quantity of characters corresponding to each type of font, and obtaining standard bitmaps of the preset quantity characters based on a standard font; and
comparing the pattern bitmap with the standard bitmap to obtain pattern similarity, determining the average similarity according to the pattern similarity of each character, judging whether the average similarity is greater than or equal to the preset threshold.

9. The character conversion method according to claim 7, further comprising:
comparing the larger value of the height and the width of the pattern bitmap with the larger value of the height and the width of the standard bitmap to obtain a pattern adjustment range; and
adjusting a first font size of the first target character according to the pattern adjustment range corresponding to the first target character, drawing the first target character according to the calibrated first font size, calibrating a second font size of the second target character according to the pattern adjustment range corresponding to the second target character, and drawing the second target character according to the calibrated second font size, and/or drawing a character that is not converted according to a font size of the character that is not converted.

10. The character conversion method according to claim 6, further comprises: identifying the pattern bitmap by an optical character recognition technology to obtain an actual inner code.

11. A non-transient storage media, storing a computer executable program for performing the character conversion method according to claim 6.
